(19) United States
(12) Patent Application Publication
(10) Pub. No.: US 2007/0292330 A1
(43) Pub. Date: Dec. 20, 2007

(54) Scintillator single crystal and process for its production

(76) Inventors: Yasushi Kurata, Hitachinaka-shi (JP); Naoaki Shimura, Hitachinaka-shi (JP); Tatsuya Usui, Hitachinaka-shi (JP); Kazuhisa Kurashige, Hitachinaka-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/723,799

(22) Filed: Mar. 22, 2007

(30) Foreign Application Priority Data
Apr. 5, 2006 (JP) P2006-104092
Sep. 15, 2006 (JP) P2006-251238

(51) Int. Cl. C01F 17/00

(52) U.S. Cl. 423/263

(57) ABSTRACT

The scintillator single crystal of the invention is a specific cerium-activated silicate single crystal wherein the total content of one or more elements selected from the group consisting of elements belonging to Groups 4, 5, 6 and Groups 14, 15, 16 of the Periodic Table is no greater than 0.002 wt % based on the total weight of the single crystal.

### BACKGROUND OF THE INVENTION

1. Field of the Invention

The present invention relates to a scintillator single crystal and to a process for its production. More specifically, it relates to a scintillator single crystal used in a single-crystal scintillation detector (scintillator) for gamma ray or other radiation in the fields of radiology, physics, physiology, chemistry, mineralogy and oil exploration, such as for medical diagnostic positron CT (PET), cosmic radiation observation, underground resource exploration and the like, as well as to a process for its production.

2. Related Background Art

Scintillators composed of cerium-activated gadolinium orthosilicate compounds have short fluorescent decay times and large radiation absorption coefficients, and are therefore employed as radiation detectors for positron CT and the like. The light output of such a scintillator is larger than that of a BGO scintillator, but is only about 20% of the light output of a NaI (T1 ) scintillator and is therefore in need of further improvement.

In recent years, scintillators have been produced using single crystals of cerium-activated lutetium orthosilicates which are typically Lu₂₍₁₋ₓ₎Ce₂ₓSiO₅ (see Japanese Patent Publication No. 2852944 (hereinafter referred to as “Publication 1”) and U.S. Pat. No. 4,958,080 (hereinafter-referred to as “Publication 2”)), and scintillators using single crystals of compounds typically represented as Gd_{2(x+y)}LnₓCe_{y}SiO₅ (where Ln is Lu or a rare earth element) (see Japanese Examined Patent Publication HEI No. 7-78215 (hereinafter referred to as “Publication 3”) and U.S. Pat. No. 5,264,154 (hereinafter referred to as “Publication 4”)). Not only are such scintillators known to have improved crystal density, but the light output of cerium-activated orthosilicate compound single crystals are known to be superior and the fluorescent decay times shorter.

Incidentally, it has been demonstrated that when certain cerium-activated silicate single crystals are grown or cooled in an oxygen-containing atmosphere (for example, an atmosphere with an oxygen concentration of 0.2 vol % or greater), or when the single crystals are grown in a low-oxygen atmosphere and then heat treated at high temperature in an oxygen-containing atmosphere, the light output can be reduced due to crystal coloration, fluorescent absorption and the like (see Japanese Patent Publication No. 2701577 (hereinafter referred to as “Publication 5”)). The Czochralski process with high-frequency heating using an Ir crucible is commonly carried out when growing cerium-activated silicate single crystals, because of the high melting points of the single crystals. However, Ir crucibles suffer vaporization when heated at high temperature in an oxygen-containing atmosphere, making it difficult to achieve stable crystal growth.

As a heat treatment method for improving the scintillation properties such as light output and energy resolution with cerium-activated gadolinium orthosilicate compound single crystals, Publication 5 discloses a method of heat treatment at high temperature (but a temperature of 50° C.-550° C. lower than the melting point of the single crystals) in a low-oxygen atmosphere. According to this publication, the scintillation properties are improved by reduction of tetravalent Ce ion, which inhibits scintillation emission, to trivalent Ce ion.

Also, Japanese Patent Public Inspection No. 2001-524163 (hereinafter referred to as “Publication 6”) describes a scintillation material based on silicate crystals containing lutetium (Lu) and cerium (Ce) and comprising oxygen vacancies o, which has the chemical composition represented by the following general formula (A).
Lu_{1-y}Me_{y}A₁₋ₓCeₓSiO_{5-z}□_{z} (A)
[wherein A is Lu and at least one element selected from the group consisting of Gd, Sc, Y, La, Pr, Nd, Sm, Eu, Tb, Dy, Ho, Er, Tm and Yb, Me is at least one element selected from the group consisting of H, Li, Be, B, C, N, Na, Mg, Al, P, S, Cl, K, Ca, Ti, V, Cr, Mn, Fe, Co, Ni, Cu, Zn, Ga, Ge, As, Se, Rb, Sr, Zr, Nb, Mo, Ru, Rh, Pd, Ag, Cd, In, Sn, Sb, Cs, Ba, Hf, Ta, W, Re, Os, Ir, Pt, Au, Hg, Tl, Pb, Bi, U and Th, x is a value of 1×10⁻⁴ to 0.2 and y is a value of 1×10⁻⁵ to 0.05.]

Publication 6 mentions 50 or more elements from H to Th as Me, as a replacement element for Lu. These elements are described as having anti-cracking effects on crystals during the cutting and production of scintillation elements, as well as effects of bringing out the waveguide properties in waveguide elements. It is further mentioned that including ions with oxidation numbers of +4, +5 and +6 (for example, Zr, Sn, Hf, As, V, Nb, Sb, Ta, Mo, W or Th) in the original reagents, or adding the necessary amounts to the scintillation material, is effective for preventing crystal cracking while also preventing formation of vacancies in the oxygen sublattice.

In addition, Japanese Examined Patent Publication SHO No. 64-6160 (hereinafter referred to as “Publication 7”) discloses a method for heating tungstic acid compound single crystals in an oxygen-containing atmosphere, at a temperature in a range of below the melting point of the crystals and above a temperature of 200° C. lower than the melting point, as a heat treatment method for improving the light output of oxide scintillators. Publication 7 teaches that tungstic acid compound single crystals are more prone to vacancies, and that light output can be increased by heating near the melting point of the crystals in an oxygen-containing atmosphere to eliminate the oxygen vacancies.

Also, Japanese Unexamined Patent Publication No. 2003-300795 (hereinafter referred to as “Publication 8”) discloses that single crystals of Gd₍₂₋ₓ₎CeₓMe_{y}SiO₅ (wherein x is 0.003-0.05, y is 0.00005-0.005 and Me is an element selected from the group consisting of Mg, Ta and Zr, or a combination thereof) can be obtained with no coloration and high transparency because the element represented by Me prevents conversion of Ce ion from trivalency to tetravalency.

### SUMMARY OF THE INVENTION

However, the cerium-activated orthosilicate compound single crystals disclosed in Publications 1-4 tend to have high background light output. Consequently, the fluorescent properties tend to vary within crystal ingots and between crystal ingots, also varying from day to day and being altered when exposed to natural irradiation such as ultraviolet rays, and hence it has been difficult to achieve stable light output properties.

When the cerium-activated silicate compound single crystals are cerium-activated silicate compound single crystals represented by the following general formula (1):
Y_{2-(x+y)}LnₓCe_{y}SiO₅ (1)
[wherein Ln represents at least one element selected from the group consisting of rare earth elements, x is a numerical value of 0-2 and y is a numerical value of greater than 0 and 0.2 or less], the following general formula (2):
Gd_{2-(z+w)}Ln_{z}Ce_{w}SiO₅ (2)
[wherein Ln represents at least one element selected from the group consisting of rare earth elements, z is a numerical value of greater than 0 and 2 or less, and w is a numerical value of greater than 0 and 0.2 or less], or the following general formula (4):
Gd₂₋₍ᵣ₊ₛ₎LuᵣCeₛSiO₅ (4)
[wherein r is a numerical value of greater than 0 and 2 or less and s is a numerical value of greater than 0 and 0.2 or less], and particularly when the single crystals comprise as Ln at least one element selected from the group consisting of Dy, Ho, Er, Tm, Yb, Lu, Y and Sc which have smaller ion radii than Tb (single crystals of a cerium-activated orthosilicate compound represented by general formula (3) below), it has been demonstrated that the following phenomenon occurs. Specifically, it has been found that if a single crystal is grown or cooled in a low-oxygen neutral or reducing atmosphere or in a vacuum, or if the grown single crystal is heated at high temperature in a low-oxygen neutral or reducing atmosphere or in a vacuum, the background light output increases and thus lowers the light output or increases variation in the fluorescent property. One possible causative factor is that growth or heat treatment of such a single crystal in a low-oxygen atmosphere produces oxygen defects in the crystal lattice. Presumably, the oxygen defects result in formation of an energy trap level, creating a background light output due to the effect of thermal excitation from that level and increasing variation in light output. The background light output due to this thermal excitation is commonly known as “afterglow”.

The heat treatment method disclosed in Publication 5 gives satisfactory results when the single crystals are Gd₂₋₍₁₋ₓ₎Ce₂₋ₓSiO₅ (cerium-activated gadolinium orthosilicate). However, the following phenomenon occurs with single crystals of the cerium-activated silicate compound represented by general formula (1) above or single crystals of the cerium-activated gadolinium silicate compounds represented by general formulas (2) and (4) above, and especially with single crystals comprising as Ln at least one element selected from the group consisting of Dy, Ho, Er, Tm, Yb, Lu, Y and Sc which have smaller ion radii than Tb. Specifically, the background light output increases, leading to the undesirable effects of reduced light output and greater variation in light output.

The present inventors have discovered that silicate single crystals comprising Lu and Ce represented by general formula (A) above as described in Publication 6, being Lu-containing orthosilicate compound single crystals, are particularly prone to oxygen defects (or oxygen lattice defects). Moreover, it was further discovered that orthosilicate compound single crystals wherein the rare earth element other than Lu is Dy, Ho, Er, Tm, Yb, Lu, Y or Sc, which have smaller ion radii than Tb, are even more prone to oxygen defects than orthosilicate compound single crystals comprising Tb or rare earth elements with larger ion radii than Tb.

It was still further discovered that even among the 50 or more elements from H to Th which are described in Publication 6 as having anti-cracking effects on crystals during the cutting and production of scintillation elements, as well as effects of bringing out the waveguide properties in waveguide elements, certain ones function effectively while other function less effectively.

When a cerium-activated silicate single crystal is heated at above a temperature that is 200° C. below the melting point of the crystal, as described in Publication 7, the light output is reduced by crystal coloration, fluorescent absorption and the like, as disclosed in Publication 5. Thus, for heat treatment of cerium-activated silicate single crystals in an oxygen-containing atmosphere, a temperature of below 1000° C. which is a temperature of more than 200° C. below the melting point of the crystals is considered unacceptable in practice.

Furthermore, Publication 8 relates to single crystals having a composition different from the compositions represented by general formulas (1), (2) and (4), while it nowhere addresses oxygen defects or background (afterglow).

The present invention has been accomplished in light of the circumstances described above, and its object is to provide a scintillator single crystal exhibiting adequately superior fluorescent properties, which is a single crystal of a cerium-activated silicate compound having a basic composition represented by general formula (1), (2) or (4), and especially a single crystal comprising-as Ln one or more elements selected from the group consisting of Dy, Ho, Er, Tm, Yb, Lu, Y and Sc which have smaller ion radii than Tb, as well as a process for its production.

The present inventors have discovered that in a single crystal composed of a specific cerium-activated silicate compound represented by general formula (1), (2) or (4) above, if the total content of one or more elements selected from the group consisting of elements belonging to Groups 4, 5, 6 and Groups 14, 15, 16 of the Periodic Table is no greater than 0.002 wt % based on the total weight of the single crystal, coloration of the crystal is inhibited and the light output properties are not impaired. Furthermore, it was discovered that limiting the total content of these elements to no greater than 0.002 wt % can prevent variation in the valency of Ce ion in the orthosilicate compound single crystal even in trace oxygen-containing atmospheres, thereby allowing oxygen defects to be further reduced by adjustment of the heat treatment atmosphere during or after growth of the single crystal, and improving the fluorescent property. The present inventors have completed the invention based on these discoveries.

In other words, the invention provides a scintillator single crystal which is a single crystal composed of a cerium-activated silicate compound represented by the following general formula (1) or (2), wherein the total content of one or more elements selected from the group consisting of elements belonging to Groups 4, 5, 6 and Groups 14, 15, 16 of the Periodic Table is no greater than 0.002 wt % based on the total weight of the single crystal.
Y_{2-(x+y)}LnₓCe_{y}SiO₅ (1)
In formula (1), Ln represents at least one element selected from the 5 group consisting of rare earth elements, x is a numerical value of 0-2 and y is a numerical value of greater than 0 and 0.2 or less.
Gd_{2-(z+w)}Ln_{z}Ce_{w}SiO₅ (2)
In formula (2), Ln represents at least one element selected from the group consisting of rare earth elements, z is a numerical value of greater than 0 and 2 or less, and w is a numerical value of greater than 0 and 0.2 or less.

The invention further provides a scintillator single crystal which is a single crystal composed of a cerium-activated silicate compound represented by the following general formula (3), wherein the total content of one or more elements selected from the group consisting of elements belonging to Groups 4, 5, 6 and Groups 14, 15, 16 of the Periodic Table is no greater than 0.002 wt % based on the total weight of the single crystal.
Gd_{2-(p+q)}LnₚCe_{q}SiO₅ (3)
In formula (3), Ln represents at least one element selected from the group consisting of Dy, Ho, Er, Tm, Yb, Lu, Y and Sc which are rare earth elements having smaller ion- radii than Tb, p is a numerical value of greater than 0 and 2 or less, and q is a numerical value of greater than 0 and 0.2 or less.

The invention further provides a scintillator single crystal which is a single crystal composed of a cerium-activated silicate compound represented by the following general formula (4), wherein the total content of one or more elements selected from the group consisting of elements belonging to Groups 4, 5, 6 and Groups 14, 15, 16 of the Periodic Table is no greater than 0.002 wt % based on the total weight of the single crystal.
Gd₂₋₍ᵣ₊ₛ₎LuᵣCeₛSiO₅ (4)
In formula (4), r is a numerical value of greater than 0 and 2 or less, and s is a numerical value of greater than 0 and 0.2 or less.

The invention still further provides the aforementioned scintillator single crystal wherein the total content of one or more elements selected from the group consisting of Zr, Hf, Ti, Ta, V, Nb, W, Mo and Cr which are elements belonging to Groups 4, 5, 6 of the Periodic Table is no greater than 0.002 wt % based on the total weight of the single crystal.

The invention yet further provides a process for production of the aforementioned scintillator single crystal, which process comprises a step of preparing a starting material in such a way that the total content of one or more elements selected from the group consisting of elements belonging to Groups 4, 5, 6 and Groups 14, 15, 16 of the Periodic Table is no greater than 0.002 wt % based on the total weight of the single crystal to be produced.

According to the invention it is possible to provide a scintillator single crystal exhibiting adequately superior fluorescent properties, which is a single crystal of a cerium-activated silicate compound having a basic composition represented by general formula (1), (2) or (4), and especially a single crystal comprising as Ln one or more elements selected from the group consisting of Dy, Ho, Er, Tm, Yb, Lu, Y and Sc which have smaller ion radii than Tb, as well as a process for its production.

### BRIEF EXPLANATION OF THE DRAWINGS

FIG. 1 is a schematic cross-sectional view of an example of the basic construction of a growth apparatus for growth of a single crystal.

### DESCRIPTION OF THE PREFERRED EMBODIMENTS

It is known that when single crystals of a cerium-activated rare-earth orthosilicate compound are grown or heat-treated in an oxygen-containing atmosphere, the trivalent cerium ion acting as the luminescent center is converted to tetravalent cerium ion, and the resulting reduction in luminescent centers and increase in fluorescent absorption due to crystal coloration leads to lower light output. This phenomenon tends to be more pronounced with a higher oxygen concentration of the atmosphere and with higher heating temperature.

Cerium ion is present in trivalent form in certain cerium-activated rare-earth orthosilicate compound single crystals which are grown or cooled in a low-oxygen neutral or reducing atmosphere or in a vacuum, or which are heated in a low-oxygen neutral or reducing atmosphere or in a vacuum. Presumably this inhibits both crystal coloration and absorption of fluorescence due to such coloration to a sufficient extent to yield high light output. Even when single crystals of a cerium-activated rare-earth orthosilicate compound are grown or cooled in an oxygen-containing atmosphere, or are heated in an oxygen-containing atmosphere, resulting in reduced light output, subsequent heat treatment in a low-oxygen atmosphere is associated with restoration of tetravalent cerium ion to trivalent cerium ion, and therefore to more luminescent centers and reduced crystal coloration. This is known to improve the transmittance of the single crystals, thereby increasing the light output. This phenomenon tends to be more pronounced with a lower oxygen concentration of the atmosphere, with a higher reducing gas (such as hydrogen) concentration of the atmosphere, and with a higher heating temperature.

In actuality it has been confirmed that growth and high-temperature heat treatment of Gd₂₋₍₁₋ₓ₎Ce₂₋ₓSiO₅ (cerium-activated gadolinium orthosilicate) single crystals in a low-oxygen atmosphere as mentioned above results in a satisfactory fluorescent property and an enhancing effect on the fluorescent property. For example, Publication 5 discloses a heat treatment method for cerium-activated gadolinium orthosilicate compound single crystals wherein the heat treatment is carried out in a low-oxygen atmosphere at a high temperature (a temperature of 50° C.-550° C. lower than the melting point of the single crystals).

However, it has been shown that the following phenomenon occurs with single crystals of the cerium-activated silicate compound represented by general formula (1) above and with single crystals of the cerium-activated gadolinium silicate compounds represented by general formulas (2) and (4) above, and especially with single crystals comprising as Ln at least one element selected from the group consisting of Dy, Ho, Er, Tm, Yb, Lu, Y and Sc which have smaller ion radii than Tb. Specifically, it has been demonstrated that growth or cooling of the single crystals in a low-oxygen neutral or reducing atmosphere or in a vacuum, or heat treatment in a low-oxygen neutral or reducing atmosphere or in a vacuum, leads to disadvantageous effects such as increased background light output and greater variation in light output. This phenomenon tends to be more pronounced with a lower oxygen concentration of the atmosphere, with a higher reducing gas (such as hydrogen) concentration of the atmosphere, and with a higher heating temperature.

One possible causative factor is that growth or heat treatment of such single crystals in a low-oxygen atmosphere produces oxygen defects in the crystal lattice. Presumably, the oxygen defects result in formation of an energy trap level, creating a background light output due to the effect of thermal excitation from that level and increasing variation in the light output.

The oxygen defects from the aforementioned cerium-activated orthosilicate compound single crystals tend to be fewer if the single crystals are grown in an oxygen-rich atmosphere. However, growth of single crystals in an oxygen-rich atmosphere promotes conversion of trivalent cerium ion (Ce³⁺) to tetravalent cerium ion (Ce⁴⁺), thereby lowering the luminescent wavelength transmittance and reducing the light output. Most of such orthosilicate single crystals have extremely high melting points of above 1600° C. The orthosilicate single crystals are grown by the Czochralski process which generally involves high-frequency heating in an Ir crucible, but exposing an Ir crucible to an oxygen-containing atmosphere at high temperatures of 1500° C. and above causes notable vaporization of Ir and tends to hinder crystal growth. Because of these two problems, cerium-activated orthosilicate single crystals are usually grown in low-oxygen neutral or reducing atmospheres, and consequently the issue of oxygen defects arises in the crystal growth stage.

Oxygen defects in cerium-activated orthosilicates tend to occur with crystal compositions that are inclined toward a C2/c crystal structure. A P2₁/c crystal structure will tend to be produced by using as Ln at least one element selected from the group consisting of La, Pr, Nd, Pm, Sm, Eu, Ga and Tb which have larger ion radii than Tb, for single crystals of the cerium-activated silicate compound represented by general formula (1) above and for single crystals of the cerium-activated gadolinium silicate compounds represented by general formulas (2) and (4) above. On the other hand, using as Ln at least one element selected from the group consisting of Dy, Ho, Er, Tm, Yb, Lu, Y and Sc which have smaller ion radii than Tb will tend to produce a C2/c crystal structure. Such single crystals that tend to have a C2/c crystal structure are more prone to increased background light output and variation in light output. This is believed to be because a larger difference between the ion radius of the activator Ce and the ion radius of the orthosilicate compound element results in more of the aforementioned oxygen defects.

In fact, in the case of single crystals of the cerium-activated gadolinium silicate compounds represented by general formula (2) above, the oxygen defects tend to be more abundant with a higher compositional ratio of Ln with small ion radii. With single crystals of cerium-activated orthosilicic acid compounds that are prone to oxygen defects due to the aforementioned crystal composition, it is believed that oxygen defects still occur even with heating in a neutral atmosphere or in a trace oxygen-containing neutral atmosphere or reducing atmosphere, or heating at a lower temperature.

Furthermore, it is thought that even Lu₂₋₍₁₋ₓ)Ce₂₋ₓSiO₅ (cerium-activated lutetium orthosilicate) single crystals having a C2/c crystal structure are prone to oxygen defects because of the large difference in ion radius compared to Ce ion.

With the aforementioned cerium-activated orthosilicate compound single crystals, a large difference between the ion radius of the constituent rare earth element and the ion radius of Ce will significantly reduce the segregation coefficient of Ce incorporated into the crystals from the crystal melt during crystal growth by the Czochralski process. The tendency toward varying Ce concentration in the crystal ingot is therefore another possible cause of variation in the crystal light output and background (afterglow).

For the Ce concentration in the scintillator single crystal of the invention, the values of y, w, q and s in general formulas (1), (2), (3) and (4) above are preferably greater than 0 and no greater than 0.2, more preferably 0.0001-0.02 and even more preferably 0.0005-0.005. When the numerical value is 0, no Ce (activator) is present and therefore no luminescent level is formed and fluorescence is not exhibited. If the numerical value is greater than 0.2, the amount of Ce incorporated in the crystals will be saturated, thus diluting the effect of Ce addition and producing voids or defects due to segregation of Ce, and thereby tending to impair the fluorescent property.

Upon examining the single crystal compositions of cerium-activated silicate compounds capable of inhibiting reduced light output due to oxygen defects and improving light output over the prior art, the present inventors discovered that it is effective for the total content of elements belonging to Groups 4, 5, 6 and 14, 15, 16 of the Periodic Table to be no greater than 0.002 wt %. It was found particularly effective for the total content of the one or more elements selected from the group consisting of Zr, Hf, Ti, Ta, V, Nb, W, Mo and Cr belonging to Groups 4, 5, 6 of the Periodic Table to be no greater than 0.002 wt % with respect to elements belonging to Groups 4, 5, 6 and 14, 15, 16 of the Periodic Table.

As mentioned above, Publication 6 teaches that when ions having oxidation numbers of +4, +5 and +6 (for example, Zr, Sn, Hf, As, V, Nb, Sb, Ta, Mo, W, Th) are present in the original reagents, or when the necessary amounts thereof are added to the scintillation material, cracking of the crystal is effectively prevented and formation of vacancies in the oxygen sublattice is inhibited.

The present inventors have found, however, that when the ions having oxidation numbers of +4, +5 and +6 (for example, Zr, Sn, Hf, As, V, Nb, Sb, Ta, Mo, W, Th) mentioned in Publication 6 are present in the original reagents, or when they are added to the scintillation material, the crystal undergoes coloration and tends to have reduced light output.

This is attributed to the accelerated conversion of Ce ion from trivalent to tetravalent, which is an opposing effect to the charge compensation described in Publication 6. In particular, when trace oxygen is combined with the heat treatment atmosphere either during or after growth to prevent oxygen defects, the Ce ion valence number conversion is further accelerated, thus notably reducing the fluorescent property. The aforementioned elements promote Ce ion valence number conversion, and it is possible that sufficiently lowering the contents of those elements inhibits Ce ion valence number conversion to produce excellent fluorescent properties. However, the cause and effect relationship, as concerns lowering the total content of specific elements according to the invention, is not limited to the effect described above.

For orthosilicate single crystals according to the invention, the total content of elements belonging to Groups 4, 5, 6 and 14, 15, 16 of the Periodic Table must be no greater than 0.002 wt %, but it is preferably no greater than 0.001 wt % and most preferably no greater than 0.0002 wt %. If the content exceeds 0.002 wt %, the reduction in properties will become significant and depending on the type of elements included, especially those of Group 4 of the Periodic Table (for example, Zr, Hf), the resulting impairment of the fluorescent property can no longer be ignored. The content of elements belonging to Groups 4, 5, 6 and 14, 15, 16 of the Periodic Table may be measured by GD-MS (Glow Discharge Mass Spectrometry).

Elements belonging to Groups 4, 5, 6 and 14, 15, 16 of the Periodic Table substitute Gd or rare earth element sites with a high degree of probability. Representing the one or more elements selected from the group consisting of elements belonging to Groups 4, 5, 6 and 14, 15, 16 of the Periodic Table as M, the following general formula (5) results.
Gd_{2-(p+q+z)}LnₚCe_{q}M_{z}SiO₅ (5)
In formula (5), Ln represents at least one element selected from the group consisting of Dy, Ho, Er, Tm, Yb, Lu, Y and Sc which are rare earth elements having smaller ion radii than Tb, p is a numerical value of greater than 0 and 2 or less, and q is a numerical value of greater than 0 and 0.2 or less.

For example, When M in formula (5) is Zr, the rare earth element is Ln and p is 1.8, an M content range of no greater than 0.002 wt % based on the total weight of the single crystal corresponds to z≦0.0001, a range of no greater than 0.001 wt % corresponds to z≦0.00005, and a range of no greater than 0.0002 wt % corresponds to z≦0.00001.

Growth of the scintillator single crystal of the invention can be accomplished according to ordinary orthosilicate compound single crystal growth methods, except that the total content of one or more elements selected from the group consisting of elements belonging to Groups 4, 5, 6 and Groups 14, 15, 16 of the Periodic Table in the starting material used is no greater than 0.002 wt % based on the total weight of the single crystal.

The starting material used is preferably one wherein the total content of one or more elements selected from the group consisting of elements belonging to Groups 4, 5, 6 and Groups 14, 15, 16 of the Periodic Table is no greater than 0.002 wt % based on the total weight of the single crystal at the time the starting material for the single crystal is prepared. The elements belonging to Groups 4, 5, 6 and Groups 14, 15, 16 of the Periodic Table are taken into the single crystal in a manner based on the distribution coefficient (segregation coefficient) from the starting material to the crystal, that is potentially affected by the difference in ion radius between the rare earth element in the base crystal of the orthosilicate compound single crystal of the invention. Since the distribution coefficient is less than 1, the concentration of the aforementioned elements present in the single crystal will tend to be smaller than the amounts added to the starting material.

The ion radii of elements belonging to Groups 4, 5, 6 and Groups 14, 15, 16 of the Periodic Table which are present in the orthosilicate compound single crystal can potentially affect the single crystal coloration and fluorescent property. The ion radii mentioned below are cited from the web page of the Hiroshima University Earth Resources Research Laboratory (http://home.hiroshima-u.ac.jp/er/Min_G2.html, as of Jun. 8, 2005) (empirical radii according to Shannon and Prewitt (1969,70), partly from Shannon (1976) and partly the values estimated by Pauling (1960) or Ahrens (1952)).

The elements belonging to Groups 4, 5, 6 and Groups 14, 15, 16 of the Periodic Table in the orthosilicate compound single crystal of the invention are believed to be present at the rare earth element sites such as Lu or Gd, or at the interstitial sites. Particularly when they are present at sites of rare earth elements such as Lu, Y or Gd or when substituting at crystal lattice sites, elements having ion radii that are closer to the ion radii of elements in the base crystal (40 pm for Si, 98 pm for Lu, 102 pm for Y, 105 pm for Gd) readily substitute at the rare earth element lattice sites, and are therefore believed to have greater effects on the coloration and fluorescent property of the single crystal. Here, 1 pm=0.01 Å.

As elements belonging to Groups 4, 5, 6 and Groups 14, 15, 16 of the Periodic Table there may be mentioned Ti (ion radius: 61 pm), Zr (ion radius: 72 pm) and Hf (ion radius: 71 pm) of Group 4 and Ge (ion radius: 54 pm), Sn (ion radius: 69 pm) and Pb (ion radius: 78 pm) of Group 14, which readily form tetravalent ions, V (ion radius: 64 pm), Nb (ion radius: 64 pm) and Ta (ion radius: 64 pm) of Group 5 and P (ion radius: 17 pm), As (ion radius: 34 pm) and Sb (ion radius: 61 pm) of Group 15 which readily form pentavalent ions, Cr (ion radius: 30 pm), Mo (ion radius: 60 pm) and W (ion radius: 60 pm) of Group 6 and S (ion radius: 12 pm), Se (ion radius: 29 pm) and Te (ion radius: 56 pm) of Group 16 which readily form hexavalent ions, and the like. These elements adversely affect the properties in the order of tetravalent>pentavalent>hexavalent, which are near the valences of the elements in the base crystal. Of the elements mentioned above, Zr and Hf which have relatively large ion radii and whose ion radii are close to those of the elements composing the base crystal, have a particularly adverse effect on the properties. Therefore, the content of both of these elements in the crystal is preferably reduced to an satisfactory level.

As mentioned above, the present inventors discovered that tetravalent, pentavalent and hexavalent elements produce coloration in rare earth silicate single crystals and reduce the light output. As concerns the effect of the valences of impurity elements, it was found that for a given molar concentration in the starting material, the effect on properties tended to be largest for elements belonging to Group 4 of the Periodic Table.

A cerium-activated orthosilicate single crystal of the invention will tend to have an increased oxygen defect density when the crystal is grown or cooled in a low-oxygen neutral or reducing atmosphere, or a vacuum. When the crystal has been grown or cooled and heated in a low-oxygen atmosphere in order to reduce oxygen defects, the crystal will tend to undergo coloration and reduced light output, and the aforementioned effect of the invention will be more effectively exhibited.

Single crystals of compounds represented by general formulas (1) and (2) have a high proportion with respect to Ln of one or more elements selected from the group consisting of Dy, Ho, Er, Tm, Yb, Lu, Y and Sc, which have large differences in ion radii compared to cerium and smaller ion radii than Tb, and the effect of the invention is more effectively exhibited as the crystal structure approaches C2/c.

A process for production of a scintillator single crystal according to a preferred embodiment of the invention will now be explained. The process for production of a scintillator single crystal comprises a starting material preparation step wherein a starting material is prepared so that the total content of one or more elements selected from the group consisting of elements belonging to Groups 4, 5, 6 and Groups 14, 15, 16 of the Periodic Table is no greater than 0.002 wt % based on the total weight of the single crystal to be produced, a growth step in which a single crystal is grown from the prepared starting material, and a heating step in which the single crystal ingot obtained from the growth step is heat treated under prescribed conditions.

In the starting material preparation step, a starting material is prepared comprising a mixture with a sufficiently low content of elements belonging to Groups 4, 5, 6 and Groups 14, 15, 16 of the Periodic Table. The constituent element of the base crystal is prepared as an oxide (simple oxide or complex oxide) or a salt such as a carbonate (simple or complex salt), and it may be in the form of a solid powder, for example. The total content of one or more elements selected from the group consisting of elements belonging to Groups 4, 5, 6 and 14, 15, 16 of the Periodic Table is preferably no greater than 0.002 wt % based on the total weight of the single crystal starting material.

The growth step further comprises a melting step in which a melt is obtained by melting the aforementioned prepared starting material by a melting process, and a cooling/solidification step in which a single crystal ingot is obtained by cooling the melt to a solid.

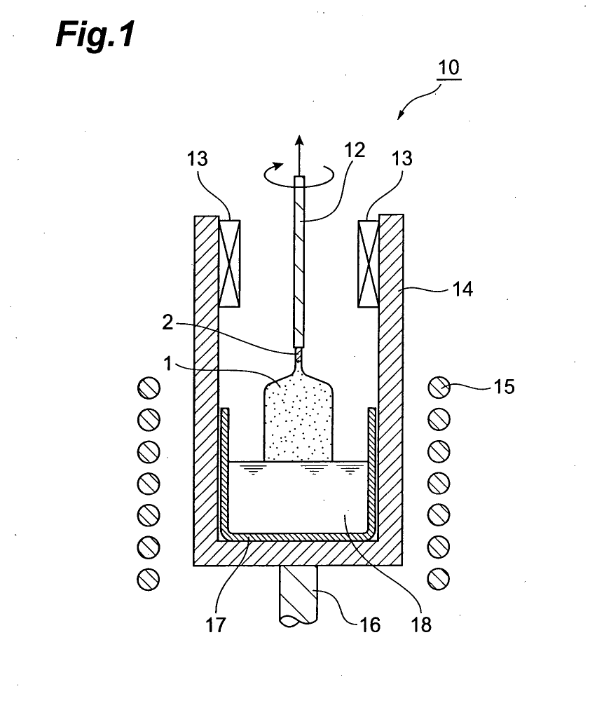

The melting process of the melting step may be the Czochralski process. In this case, a lifting apparatus 10 having the construction shown in FIG. 1 is preferably used for the operation in the melting step and cooling/solidification step.

FIG. 1 is a schematic cross-sectional view of an example of the basic construction of a growth apparatus for growth of a single crystal according to the invention. The lifting apparatus 10 shown in FIG. 1 has a high-frequency induction heating furnace 14. The high-frequency induction heating furnace 14 is used for continuous operation in the melting step and the cooling and solidification step described above.

The high-frequency induction heating furnace 14 is a refractory cylindrical walled, closed-bottom vessel, and the shape of the closed-bottom vessel is the same type as one used for single crystal growth based on the publicly known Czochralski process. A high-frequency induction coil 15 is wound on the outside of the bottom of the high-frequency induction heating furnace 14. Also, a crucible 17 (for example, a crucible made of Ir) is set on the bottom inside the high-frequency induction heating furnace 14. The crucible 17 also serves as a high-frequency induction heater. The starting material for the single crystal is loaded into the crucible 17, and application of high-frequency induction to the high-frequency induction coil 15 heats the crucible 17 and produces a melt 18 composed of the constituent material of the single crystal.

At the center bottom of the high-frequency induction heating furnace 14 there is provided an opening (not shown) which passes from the inside to the outside of the high-frequency induction heating furnace 14. Through this opening there is inserted a crucible support rod 16, from the outside of the high-frequency induction heating furnace 14, and the end of the crucible support rod 16 is connected to the bottom of the crucible 17. Rotating the crucible support rod 16 allows the crucible 17 to be rotated in the high-frequency induction heating furnace 14. The area between the opening and the crucible support rod 16 is sealed with packing or the like.

A more specific production process using a lifting apparatus 10 will now be explained.

First in the melting step, the starting material for the single crystal is loaded into the crucible 17 and high-frequency induction is applied to the high-frequency induction coil 15 to obtain a melt 18 composed of the constituent material for the single crystal. The single crystal starting material may be, for example, a simple oxide and/or complex oxide of the metal element in the single crystal. Preferred are the high-purity commercial products by Shin-Etsu Chemical Co., Ltd., Stanford Materials Corp. and Tama Chemicals Co., Ltd.

Next, in the cooling and solidification step, the melt is cooled to solid to obtain a cylindrical single crystal ingot 1. More specifically, the operation proceeds through two separate steps, the crystal growth step described below and a cooling step.

First in the crystal growth step, a lifting rod 12 having a seed crystal 2 affixed to its lower end is loaded into the melt 18 from the top of the high-frequency induction heating furnace 14, and then the lifting rod 12 is lifted while forming a single crystal ingot 1. During this time, the heating output from the heater 13 is adjusted in the crystal growth step, so that the single crystal ingot 1 raised from the melt 18 grows to have a cross-section with the prescribed diameter.

Next, in the cooling step, the heating output of the heater is adjusted for cooling of the grown single crystal ingot (not shown) obtained after the crystal growth step.

The cerium-activated orthosilicate single crystal of the invention may also be heated in a low-oxygen atmosphere (for example, an atmosphere with an argon and nitrogen combined concentration of 80 vol % or greater, an oxygen concentration of less than 0.2 vol % and if necessary a hydrogen gas concentration of at least 0.5 vol %). Here, the heating temperature may be a temperature Tb (units: ° C.) satisfying the condition represented by inequality (6) below. The oxygen-containing atmosphere may then be replaced and the single crystal heated at a heating temperature of 300° C.-1500° C. in that atmosphere.
800≦T_{b}≦(Tₘ−550) (6)
[where Tₘ (units: ° C.) represents the melting point of the single crystal.]

This type of heat treatment can further reduce oxygen defects formed in the single crystal.

The cerium-activated orthosilicate single crystal ingot of the invention obtained by the growth step may then be heated in a low-oxygen atmosphere (for example, an atmosphere with an argon and nitrogen combined concentration of 80 vol % or greater, an oxygen concentration of less than 0.2 vol % and if necessary a hydrogen gas concentration of at least 0.5 vol %). Here, the heating temperature may be a temperature T₃ (units: ° C.) satisfying the condition represented by inequality (7) below. This kind of heat treatment can prevent increase in oxygen defects in the crystal while efficiently converting Ce⁴⁺ to Ce³⁺.
800≦T₃≦(Tₘ₃−550) (7)
[where Tₘ₃ (units: ° C.) represents the melting point of the single crystal.]

The aforementioned heating step in the scintillator single crystal production process of the invention may optionally be omitted.

The present invention relates to the aforementioned cerium-activated orthosilicate single crystal having improved scintillator properties including light output, background light output and energy resolution, and to a process for its production. The valence state of cerium ion in the cerium-activated orthosilicate single crystal significantly affects the light output. Conversion from the trivalent state of cerium ion as a luminescent center to tetravalent cerium ion as a non-luminescent center by coloration and fluorescence absorption occurs as a result of heating in an oxygen-containing atmosphere. Consequently, growth of the single crystal is carried out in a low-oxygen neutral or reducing atmosphere or in a vacuum. However, growth of the single crystal under these conditions produces oxygen defects in the single crystal. The oxygen defects produced in the single crystal significantly affect the background light output, thereby increasing the variation in fluorescence within the fluorescent crystal ingot or between ingots, on different days, and with different periods of exposure to irradiation including ultraviolet rays. The oxygen defects are thought to occur due to crystal growth and/or cooling at high temperature relatively near the crystal melting point and in a low-oxygen atmosphere, or by heat treatment.

The present invention is effective for preventing oxygen defects during growth, cooling and heating of the single crystal, and for inhibiting valence conversion of cerium ion from trivalent to tetravalent, even when the single crystal is grown, cooled and heated in an oxygen-containing atmosphere. The invention was completed based on the discovery that crystal coloration in oxygen-containing atmospheres can be inhibited and the light output property can be improved by reducing the tetra-, penta- and hexavalent impurity concentration which promotes conversion of cerium ion from trivalent to tetravalent.

### EXAMPLES

The present invention will now be explained in greater detail through the following examples, with the understanding that these examples are in no way limitative on the invention.

### Example 1

A single crystal was produced by the publicly known Czochralski process. First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %), in the prescribed stoichiometric composition, was prepared and loaded in an Ir crucible with a diameter of 50 mm, a height of 50 mm and a thickness of 2 mm, as the starting material for a Gd₂₋₍ᵣ₊ₛ₎LuᵣCeₛSiO₅ (r=1.8, s=0.003) single crystal. The tetra-, penta- and hexavalent elements (impurities) in the respective starting materials for gadolinium oxide, lutetium oxide and silicon dioxide were all less than 1 ppm by weight.

The mixture was then heated to the melting point (about 2050° C.) in a high-frequency induction heating furnace to obtain a melt. The melting point was measured using an electronic optical pyrometer (Pyrostar MODEL UR-U™ by Chino Corp.).

Next, the end of the lifting rod to which the seed crystal was anchored was placed in the melt for crystal growth. The single crystal ingot was then lifted at a lifting speed of 1.5 mm/h to form the neck section. The cone section was lifted, and lifting of the cylinder trunk was initiated at a lifting speed of 1 mm/h when the diameter reached 25 mmφ. The cylinder trunk was grown, and then the single crystal ingot was cut off from the melt and cooling was initiated. During growth and cooling of the crystal, N₂ gas was continuously circulated at a flow rate of 4 L/min in addition to O₂ gas at a flow rate of 10 mL/min in the growing furnace. The oxygen concentration in the furnace was confirmed to be 0.2-0.3 vol % by measurement using a galvanic cell diffusion-type oxygen analyzer (Model OM-25MS10 by Taiei Electric Co., Ltd.)

After cooling was complete, the obtained single crystal was taken out. The obtained single crystal ingot had a crystal weight of approximately 250 g, a cone section length of about 30 mm and a cylinder trunk length of about 70 mm.

Several 4 mm×6 mm×20 mm rectangular crystal samples were cut out from the obtained single crystal ingot. Each cut out crystal sample was subjected to chemical etching with phosphoric acid, for mirror surfacing of the entire crystal sample surface.

Next, two crystal samples were arbitrarily taken from the mirror surfaced crystal samples and covered with polytetrafluoroethylene (PTFE) tape as a reflecting material on five sides of the 4 mm×6 mm×20 mm six-sided rectangular crystal sample, leaving one of the 4 mm×6 mm sides as the “radiation incident side”. The radiation incident side of each sample which was not covered with PTFE tape was attached to the photomultiplier side (photoelectric conversion side) of a photomultiplier tube (R878 by Hamamatsu Photonics, K.K.) using optical grease. Each sample was then irradiated with 662 KeV gamma rays using ¹³⁷Cs, and the energy spectrum of each sample was measured. The light output, energy resolution and background of each sample were evaluated. The energy spectrum was measured with an MCA (Quantum MCA4000 by PGT) while applying a voltage of 1.45 kV to the photomultiplier tube and amplifying the signal from the dynode using a preamplifier (“113” by ORTEC) and a waveform shaping amplifier (“570” by ORTEC). Coloration of the crystal ingot was evaluated by external visual observation. The results are shown in Table 1.

### Example 2

First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %), in the prescribed stoichiometric composition as the starting materials for a Gd₂₋₍ᵣ₊ₛ₎LuᵣCeₛSiO₅ (r=1.8, s=0.003) single crystal, was loaded in an Ir crucible with a diameter of 50 mm, a height of 50 mm and a thickness of 2 mm, together with 0.0881 g of calcium carbonate (CaCO₃, purity: 99.99 wt %) (corresponding to 0.0070 wt % as Ca). The tetra-, penta- and hexavalent elements (impurities) in the respective starting materials for gadolinium oxide, lutetium oxide and silicon dioxide were all less than 1 ppm by weight. The procedure thereafter was conducted in the same manner as Example 1.

### Example 3

A single crystal of Y_{2-(x+y)}LuₓCe_{y}SiO₅ (x=1.8, y=0.003) instead of the Gd₂₋₍ᵣ₊ₛ₎LuᵣCeₛSiO₅ (r=1.8, s=0.003) in Example 1 was produced in the following manner. Yttrium oxide (Y₂O₃, purity: 99.99 wt %) was used instead of the gadolinium oxide (Gd₂O₃, purity: 99.99 wt %) used in Example 1, and into 500 g of a mixture with the prescribed stoichiometric composition there was loaded 0.0804 g of calcium carbonate (CaCO₃, purity: 99.99 wt %) (corresponding to 0.0072 wt % of Ca) in the same manner as Example 2. The tetra-, penta- and hexavalent elements (impurities) in the respective starting materials for yttrium oxide, lutetium oxide and silicon dioxide were all less than 1 ppm by weight. The procedure thereafter was conducted in the same manner as Example 1.

### Comparative Example 1

First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %) in the prescribed stoichiometric composition, was loaded in an Ir crucible with a diameter of 50 mm, a height of 50 mm and a thickness of 2 mm in the same manner as Example 1, as the starting materials for a Gd₂₋₍ᵣ₊ₛ₎LuᵣCeₛSiO₅ (r=1.8, s=0.003) single crystal. For this comparative example, 0.0542 g of zirconium oxide (ZrO₂, purity: 99.99 wt %) (corresponding to 0.0080 wt % as Zr) was additionally loaded. The tetra-, penta- and hexavalent elements (impurities) in the respective starting materials for gadolinium oxide, lutetium oxide and silicon dioxide were all less than 1 ppm by weight. The procedure thereafter was conducted in the same manner as Example 1.

### Comparative Example 2

A sample was prepared and evaluated in the same manner as Comparative Example 1, except that that 0.0926 g of hafnium oxide (HfO₂, purity: 99.99 wt %) (corresponding to 0.0157 wt % as Hf) was loaded instead of 0.0542 g of zirconium oxide (ZrO₂, purity: 99.99 wt %) (corresponding to 0.0080 wt % as Zr).

### Comparative Example 3

A sample was prepared and evaluated in the same manner as Comparative Example 1, except that 0.0972 g of tantalum oxide (Ta₂O₅, purity: 99.99 wt %) (corresponding to 0.0159 wt % as Ta) was loaded instead of 0.0542 g of zirconium oxide (ZrO₂, purity: 99.99 wt %) (corresponding to 0.0080 wt % as Zr).

### Comparative Example 4

A sample was prepared and evaluated in the same manner as Comparative Example 1, except that 0.1020 g of tungsten oxide (WO₃, purity: 99.99 wt %) (corresponding to 0.0162 wt % as W) was loaded instead of 0.0542 g of zirconium oxide (ZrO₂, purity: 99.99 wt %) (corresponding to 0.0080 wt % as Zr).

### Comparative Example 5

First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %) in the prescribed stoichiometric composition, as the starting material for a Gd₂₋₍ᵣ₊ₛ₎LuᵣCeₛSiO₅ (r=1.8, s=0.003) single crystal, was loaded in an Ir crucible with a diameter of 50 mm, a height of 50 mm and a thickness of 2 mm in the same manner as Example 2, together with 0.0881 g of calcium carbonate (CaCO₃, purity: 99.99 wt %) (corresponding to 0.0071 wt % as Ca). For this comparative example, 0.0163 g of zirconium oxide (ZrO₂, purity: 99.99 wt %) (corresponding to 0.0024 wt % as Zr) was additionally loaded. The procedure thereafter was conducted in the same manner as Example 2. The tetra-, penta- and hexavalent elements (impurities) in the respective starting materials for gadolinium oxide, lutetium oxide and silicon dioxide were all less than 1 ppm by weight.

### Comparative Example 6

First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %) in the prescribed stoichiometric composition, as the starting material for a Gd₂₋₍ᵣ₊ₛ₎LuᵣCeₛSiO₅ (r=1.8, s=0.003) single crystal, was loaded in an Ir crucible with a diameter of 50 mm, a height of 50 mm and a thickness of 2 mm in the same manner as Example 2, together with 0.0881 g of calcium carbonate (CaCO₃, purity: 99.99 wt %) (corresponding to 0.0070 wt % as Ca). For this comparative example, the sample was prepared and evaluated in the same manner as Example 2, except that 0.0486 g of tantalum oxide (Ta₂O₅, purity: 99.99 wt %) (corresponding to 0.0080 wt % as Ta) was additionally loaded.

### Comparative Example 7

A single crystal of Y_{2-(x+y)}LuₓCe_{y}SiO₅ (x=1.8, y=0.003) was produced in the following manner instead of the Gd₂₋₍ᵣ₊ₛ₎LuᵣCeₛSiO₅ (r=1.8, s=0.003) of Comparative Example 1. Yttrium oxide (Y₂O₃, purity: 99.99 wt %) was used instead of the gadolinium oxide (Gd₂O₃, purity: 99.99 wt %) used in Comparative Example 1, and into 500 g of a mixture with the prescribed stoichiometric composition there was loaded 0.0559 g of zirconium oxide (ZrO₂, purity: 99.99 wt %) (corresponding to 0.0083 wt % as Zr). The tetra-, penta- and hexavalent elements (impurities) in the respective starting materials for yttrium oxide, lutetium oxide and silicon dioxide were all less than 1 ppm by weight. The procedure thereafter was conducted in the same manner as Comparative Example 1.

TABLE 1

| | | | | Energy | | Crystal |
|---|---|---|---|---|---|---|
| | Crystal | Added | Light output | resolution | Background | ingot |
| | composition | element/content | (ch) | (%) | (mV) | coloration |
| Example 1 | Gd₂₋₍ᵣ₊ₛ₎LuᵣCeₛSiO₅ | — | 880 | 14.0 | 30 | Absent |
| | (r = 1.8, s = 0.003) | | 1035 | 13.4 | 20 | |
| Example 2 | | Ca/0.0071 wt % | 1420 | 8.7 | 0 | Absent |
| | | | 1450 | 8.4 | 0 | |
| Example 3 | Y_{2-(x+y)}LuₓCe_{y}SiO₅ | Ca/0.0072 wt % | 1430 | 8.8 | 0 | Absent |
| | (x = 1.8, y = 0.003) | | 1410 | 9.0 | 0 | |
| Comp. Ex. 1 | Gd₂₋₍ᵣ₊ₛ₎LuᵣCeₛSiO₅ | Zr/0.0080 wt % | Unmeasurable | Unmeasurable | 20 | Present |
| | (r = 1.8, s = 0.003) | | Unmeasurable | Unmeasurable | 20 | |
| Comp. Ex. 2 | | Hf/0.0157 wt % | Unmeasurable | Unmeasurable | 20 | Present |
| | | | Unmeasurable | Unmeasurable | 20 | |
| Comp. Ex. 3 | | Ta/0.0159 wt % | 680 | 17.2 | 20 | Slight |
| | | | 820 | 13.9 | 20 | |
| Comp. Ex. 4 | | W/0.0162 wt % | 550 | 15.5 | 20 | Some |
| | | | 615 | 16.5 | 20 | |
| Comp. Ex. 5 | | Ca/0.0071 wt % | Unmeasurable | Unmeasurable | 10 | Some |
| | | Zr/0.0024 wt % | Unmeasurable | Unmeasurable | 20 | |
| Comp. Ex. 6 | | Ca/0.0071 wt % | 1254 | 9.6 | 30 | Absent |
| | | Ta/0.0080 wt % | 1150 | 10.0 | 2 | |
| Comp. Ex. 7 | Y_{2-(x+y)}LuₓCe_{y}SiO₅ | Zr/0.0083 wt % | Unmeasurable | Unmeasurable | 10 | Present |
| | (x = 1.8, y = 0.003) | | Unmeasurable | Unmeasurable | 20 | |

The term “unmeasurable” in Table 1 means that the light output was so low that the light output value and energy resolution could not be measured.

Since the tetra-, penta- and hexavalent element concentrations were less than 1 ppm in Examples 1-3 as shown in Table 1, there was no coloration of the crystal ingots and the light output was relatively high even when growth was in an oxygen-containing nitrogen atmosphere. Particularly in Examples 2 and 3, where a starting material containing no tetra-, penta- or hexavalent impurity elements was used and a prescribed amount of Ca was added as an element belonging to Group 2 of the Periodic Table, the background light output was reduced and the light output was drastically increased.

In contrast, for Comparative Examples 1-4 where the tetra-, penta- and hexavalent element concentrations in the starting material were 1 ppm but the tetravalent elements Zr and Hf. the pentavalent element Ta and the hexavalent element W were each added for testing and growth was carried out in an oxygen-containing nitrogen atmosphere, yellow coloration appeared on the crystal ingots. Of the fluorescent properties, the light output tended to be significantly reduced in a manner dependent on the extent of coloration.

In Comparative Examples 5 and 6, the starting materials used had tetra-, penta- and hexavalent element concentrations of 1 ppm with addition of a prescribed amount of Ca, as in Example 2. The properties were vastly improved with the single crystal produced in Example 2, and for Comparative Examples 5 and 6, tetravalent Zr and pentavalent Ta were each added to the composition of Example 2. For Comparative Examples 5 and 6, the Zr or Ta content was less than the Zr content in Comparative Example 1 or the Ta content in Comparative Example 3, but the ingot showed coloration and a reduction in light output was observed.

Also in Comparative Example 7, addition of Zr as a tetravalent element to the single crystal composition of Example 1 in which Gd was replaced with Y resulted in notable crystal coloration and impaired light output, similar to Comparative Example 1 in comparison to Example 1.

### Example 4

First, 500 g of a mixture of gadolinium oxide (Gd₂O₃, purity: 99.99 wt %), lutetium oxide (Lu₂O₃, purity: 99.99 wt %), silicon dioxide (SiO₂, purity: 99.9999 wt %) and cerium oxide (CeO₂, purity: 99.99 wt %), in the prescribed stoichiometric composition as the starting material for a Gd₂₋₍ᵣ₊ₛ₎LuᵣCeₛSiO₅(r=1.8, s=0.003) single crystal, was loaded in an Ir crucible with a diameter of 50 mm, a height of 50 mm and a thickness of 2 mm, together with 0.00271 g of zirconium oxide (ZrO₂, purity: 99.99 wt %) (corresponding to 0.0004 wt % as Zr). The tetra-, penta- and hexavalent elements (impurities) in the respective starting materials for gadolinium oxide, lutetium oxide and silicon dioxide were all less than 1 ppm by weight. The procedure thereafter was conducted in the same manner as Example 1.

### Example 5

A sample was prepared and evaluated in the same manner as Example 4, except that 0.00463 g of hafnium oxide (HfO₂, purity: 99.99 wt %) (corresponding to 0.0008 wt % as Hf) was loaded instead of 0.00271 g of zirconium oxide (ZrO₂, purity: 99.99 wt %) (corresponding to 0.0004 wt % as Zr).

### Example 6

A sample was prepared and evaluated in the same manner as Example 4, except that 0.0097 g of tantalum oxide (Ta₂O₅, purity: 99.99 wt %) (corresponding to 0.0016 wt % as Ta) was loaded instead of 0.00271 g of zirconium oxide (ZrO₂, purity: 99.99 wt %) (corresponding to 0.0004 wt % as Zr).

The evaluation results for the single crystals produced in Examples 4-6 are shown in Table 2. No deterioration in properties was seen when Zr, Hf and Ta were added in the amounts for Examples 4-6, and the properties were equivalent to Example 1 which contained no added elements.

TABLE 2

| | | | | Energy | | Crystal |
|---|---|---|---|---|---|---|
| | Crystal | Added | Light output | resolution | Background | ingot |
| | composition | element/content | (ch) | (%) | (mV) | coloration |
| Example 4 | Gd₂₋₍ᵣ₊ₛ₎LuᵣCeₛSiO₅ | Zr/0.0004 wt % | 950 | 13.5 | 30 | Absent |
| | (r = 1.8, s = 0.003) | | 935 | 13.9 | 30 | |
| Example 5 | | Hf/0.0008 wt % | 850 | 14.0 | 30 | Absent |
| | | | 1005 | 12.9 | 20 | |
| Example 6 | | Ta/0.0016 wt % | 890 | 13.9 | 30 | Absent |
| | | | 1025 | 13.0 | 20 | |

What is claimed is:

1. A scintillator single crystal composed of a cerium-activated silicate compound represented by the following general formula (1) or (2),
wherein the total content of one or more elements selected from the group consisting of elements belonging to Groups 4, 5, 6 and Groups 14, 15, 16 of the Periodic Table is no greater than 0.002 wt % based on the total weight of the single crystal.
Y_{2-(x+y)}LnₓCe_{y}SiO₅ (1)
[wherein Ln represents at least one element selected from the group consisting of rare earth elements, x is. a numerical value of 0-2 and y is a numerical value of greater than 0 and 0.2 or less.]
Gd_{2-(z+w)}Ln_{z}Ce_{w}SiO₅ (2)
[wherein Ln represents at least one element selected from the group consisting of rare earth elements, z is a numerical value of greater than 0 and 2 or less, and w is a numerical value of greater than 0 and 0.2 or less.]

2. A scintillator single crystal composed of a cerium-activated silicate compound represented by the following general formula (3),
wherein the total content of one or more elements selected from the group consisting of elements belonging to Groups 4, 5, 6 and Groups 14, 15, 16 of the Periodic Table is no greater than 0.002 wt % based on the total weight of the single crystal.
Gd_{2-(p+q)}LnₚCe_{q}SiO₅ (3)
[wherein Ln represents at least one element selected from the group consisting of the rare earth elements Dy, Ho, Er, Tm, Yb, Lu, Y and Sc which have smaller ion radii than Tb, p is a numerical value of greater than 0 and 2 or less, and q is a numerical value of greater than 0 and 0.2 or less.]

3. A scintillator single crystal composed of a cerium-activated silicate compound represented by the following general formula (4),
wherein the total content of one or more elements selected from the group consisting of elements belonging to Groups 4, 5, 6 and Groups 14, 15, 16 of the Periodic Table is no greater than 0.002 wt % based on the total weight of the single crystal.
Gd₂₋₍ᵣ₊ₛ₎LuᵣCeₛSiO₅ (4)
[wherein r is a numerical value of greater than 0 and 2 or less, and s is a numerical value of greater than 0 and 0.2 or less.]

4. A scintillator single crystal according to claim 1,
wherein the total content of one or more elements selected from the group consisting of Zr, Hf, Ti, Ta, V, Nb, W, Mo and Cr which are elements belonging to Groups 4, 5, 6 of the Periodic Table is no greater than 0.002 wt % based on the total weight of the single crystal.

5. A scintillator single crystal according to claim 2, wherein the total content of one or more elements selected from the group consisting of Zr, Hf, Ti, Ta, V, Nb, W, Mo and Cr which are elements belonging to Groups 4, 5, 6 of the Periodic Table is no greater than 0.002 wt % based on the total weight of the single crystal.

6. A scintillator single crystal according to claim 3,
wherein the total content of one or more elements selected from the group consisting of Zr, Hf, Ti, Ta, V, Nb, W, Mo and Cr which are elements belonging to Groups 4, 5, 6 of the Periodic Table is no greater than 0.002 wt % based on the total weight of the single crystal.

7. A process for production of a scintillator single crystal according to claim 1, comprising a step of:
preparing a starting material in such a way that the total content of one or more elements selected from the group consisting of elements belonging to Groups 4, 5, 6 and Groups 14, 15, 16 of the Periodic Table is no greater than 0.002 wt % based on the total weight of the single crystal.

8. A process for production of a scintillator single crystal according to claim 2, comprising a step of:
preparing a starting material in such a way that the total content of one or more elements selected from the group consisting of elements belonging to Groups 4, 5, 6 and Groups 14, 15, 16 of the Periodic Table is no greater than 0.002 wt % based on the total weight of the single crystal.

9. A process for production of a scintillator single crystal according to claim 3, comprising a step of:
preparing a starting material in such a way that the total content of one or more elements selected from the group consisting of elements belonging to Groups 4, 5, 6 and Groups 14, 15, 16 of the Periodic Table is no greater than 0.002 wt % based on the total weight of the single crystal.
